(19) United States
(12) Patent Application Publication
(10) Pub. No.: US 2015/0127146 A1
(43) Pub. Date: May 7, 2015

(54) SYSTEM AND METHOD FOR MODULAR ROBOTIC SYSTEM

(71) Applicant: THE TECH MUSEUM OF INNOVATION, San Jose, CA (US)

(72) Inventors: Lath B. Carlson, San Jose, CA (US); Emil C. So, Fremont, CA (US); Daniel A. Streelman, Campbell, CA (US)

(21) Appl. No.: 14/315,121

(22) Filed: Jun. 25, 2014

Related U.S. Application Data
(60) Provisional application No. 61/839,782, filed on Jun. 26, 2013.

(51) Int. Cl. B25J 9/08

(52) U.S. Cl. CPC B25J 9/08
USPC 700/245

(57) ABSTRACT

A user-customizable modular robotic method and system that includes a robot base unit that has a battery housing containing a power source and a magnetic tower connected to the battery housing that includes a plurality of magnetic sockets. The method and system further includes modular components that each include magnetic coupling members attachable to the magnetic sockets, such that the connected modular components receive power from the battery of the base unit. The modular components further include a connection port for data communication with a connected modular component and a processor that can transmit status and query data to the connected modular component. In addition, system and method include a programming station that can be patched to a particular robot that enables a user to easily customize the operation and function of the components of the patched robot using a simple touch and drag user interface.

### CROSS REFERENCE TO RELATED APPLICATIONS

This application claims the benefit of U.S. Provisional Application No. 61/839,782, filed on Jun. 26, 2013, the entire contents of which are hereby incorporated by reference.

### BACKGROUND

1. Field

The present patent document relates generally to a system and method for a robotic system, and, more particularly, to a modular robotic system and method with user-customized operational control.

2. Description of the Related Art

A variety of robotic systems are known in the art particularly for use in automated performance of various manufacturing processes, household chores, toys and the like. Conventional robotic mechanisms typically comprise an assembly of mechanical components some of which can be added and removed to provide a user with a certain level of operational customization of the robot.

Historically, the robots can be customized by connection certain components of the robot to each other, for example, connecting a sensor to a mechanical arm or the like. For such designs, these conventional robotic system require a data bus of multiple wires for data reception and transmission between the mechanical components. In particular, the communication requires a minimum of three wires (common ground, transmitting line, and receiving line) to form a simple serial communication bus between the components. This design makes the cable arrangement extremely cumbersome and inefficient when dealing with many multi-conductor cables between multiple robot modules. Moreover, while the user can establish certain functional relationships between the component based on the specific connection between the components, the customization is very limited and generally provides a simple input to output linear response. In other words, by connecting a force sensor to a mechanical arm, the arm will grab an object in response to the force sensor detecting the object or the like.

Accordingly, there is a strong felt need for a robotic system and method that enables a user to easily customize the functionality and operation of the robot.

### SUMMARY

The modular robotic system and method contemplated herein includes a robot base unit that has a battery housing containing a power source and a magnetic tower connected to the battery housing that includes a plurality of magnetic sockets. The method and system further includes modular components that each include magnetic coupling members attachable to the magnetic sockets, such that the connected modular components receive power from the battery of the base unit. The modular components further include a connection port for data communication with a connected modular component and a processor that can transmit status and query data to the connected modular component. In addition, system and method include a programming station that can be patched to a particular robot that enables a user to easily customize the operation and function of the components of the patched robot using a simple touch and drag user interface.

### BRIEF DESCRIPTION OF THE DRAWINGS

The accompanying drawings, which are included as part of the present specification, illustrate the presently preferred embodiments and, together with the general description given above and the detailed description given below, serve to explain and teach the principles of the customizable robotic system and method described herein.

FIG. 1 illustrates a perspective view of a robot base unit according to an exemplary embodiment of the present disclosure.

FIG. 2 illustrates a side view of the robot base unit according to the exemplary embodiment of the present disclosure.

FIG. 3 illustrates an underside view of the robot base unit according to the exemplary embodiment of the present disclosure.

FIG. 4 illustrates a detailed side view of the robot base unit according to the exemplary embodiment of the present disclosure.

FIG. 5 illustrates a perspective view of a robotic modular component according to an exemplary embodiment of the present disclosure.

FIG. 6 illustrates an exemplary coupling between the input modular component and connector tower of the robot base unit according to an exemplary embodiment of the present disclosure.

FIG. 7 illustrates an exemplary embodiment of the connector tower with input and output modular components coupled thereto in accordance with an exemplary embodiment.

FIGS. 8A-8C illustrate magnetic coupling members according to an exemplary embodiment of the present disclosure.

FIG. 9 illustrates an expanded view of a modular component according to an exemplary embodiment of the present disclosure.

FIGS. 10A and 10B illustrate a fan module according to an exemplary embodiment of the present disclosure.

FIGS. 11A and 11B illustrates a control modular component according to an exemplary embodiment of the present disclosure.

FIG. 12 illustrates a docking station in according to an exemplary embodiment of the present disclosure.

FIG. 13 illustrates a build station according to an exemplary embodiment of the present disclosure.

FIG. 14 illustrates a programming station according to an exemplary embodiment of the present disclosure.

FIGS. 15A and 15B provide a visual depiction of icons for exemplary input and output modules according to an embodiment of the present disclosure.

FIGS. 16A-16C illustrate an input screen that includes a plurality of icon according to an exemplary embodiment of the present disclosure.

FIGS. 17A through 17T illustrate exemplary software components according to an exemplary embodiment of the present disclosure.

FIGS. 18A-18F illustrate an exemplary method of customizing an operational program for a robot system according to an exemplary embodiment of the present disclosure.

FIGS. 19A and 19B illustrate two exemplary customized programs for the modular robotic according to an exemplary embodiment of the present disclosure.

The figures are not necessarily drawn to scale and the elements of similar structures or functions are generally represented by like reference numerals for illustrative purposes throughout the figures. The figures are only intended to facilitate the description of the various embodiments described herein; the figures do not describe every aspect of the teachings disclosed herein and do not limit the scope of the claims.

### DETAILED DESCRIPTION

A system and method for a customizable robotic system is disclosed herein. Each of the features and teachings disclosed herein can be utilized separately or in conjunction with other features and teachings. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense, and are instead taught merely to describe particularly representative examples of the present teachings.

In the following description, for purposes of explanation only, specific nomenclature is set forth to provide a thorough understanding of the robotic system and method described herein. The various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

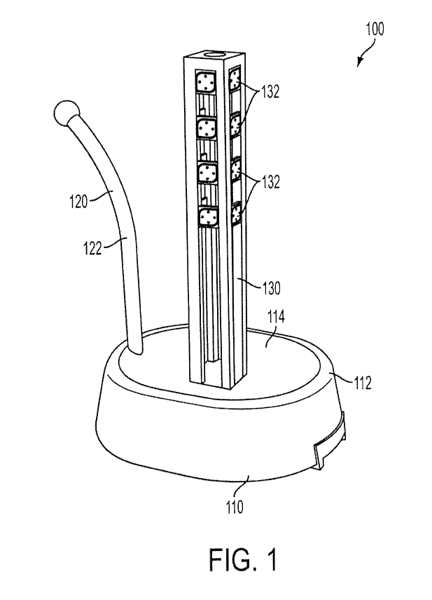

FIG. 1 illustrates a perspective view of a robot base unit 100 according to an exemplary embodiment of the present disclosure. As shown, the robot base unit 100 includes a base platform 110, a tubular handle 120, and a connector tower 130 that is designed to receive different modular components of the robot. In the exemplary embodiment, the base platform 110 has an oval-shaped perimeter 112 with a concave, inwardly facing surface 114. Preferably, the surface 114 of the robot base unit 100 includes a rubber padded surface that, among other things, will provide certain protection to prevent damage to a tubular component that may detach from the connector tower 130 or be inadvertently dropped by the user during construction. Furthermore, the tubular handle 120 includes an extended tubular arm 122, preferably made from aluminum or the like, and a circular shaped handle at the end of extended tubular arm 122, which serves as the handle for the robot the user during construction, configuration and/or operation of the robot. The connector tower 130 has a rectangular or square-shaped perimeter with a plurality of connector sockets 132 on the sides and top of the connector tower 130.

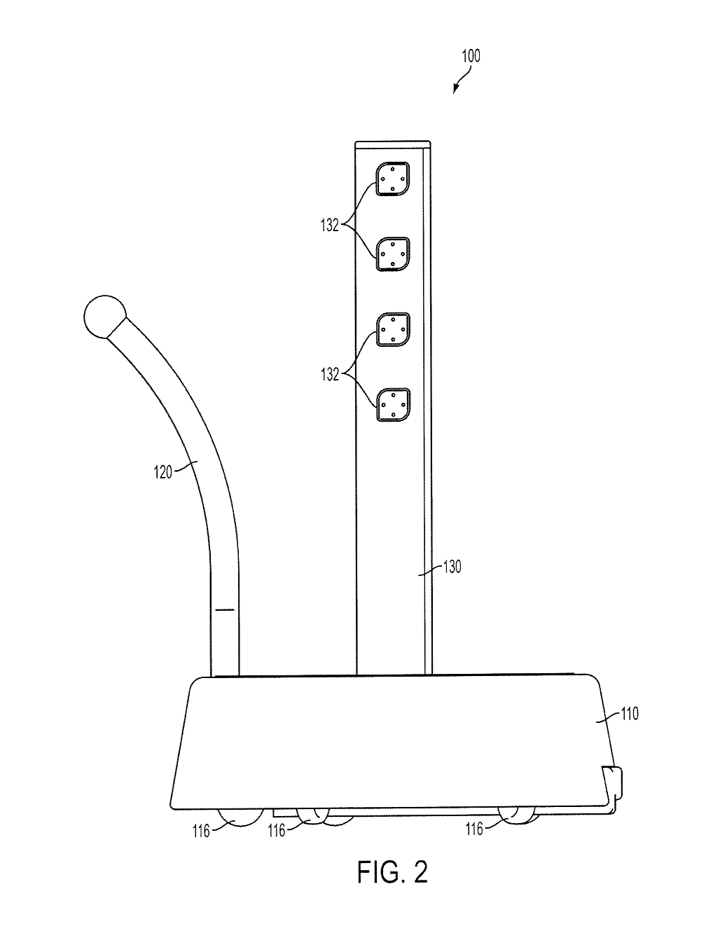

FIG. 2 illustrates a side view of the robot base unit 100 according to the exemplary embodiment of the present disclosure. As shown, the base platform 110 includes a plurality of casters 116 that facilitate 360° movement of the robot base unit 100. In one refinement of the exemplary embodiment, the casters are controlled by a motorized wheel block (not shown) that facilitates electromechanical movement of the robot during operation. Moreover, FIG. 2 illustrates each of the plurality of connector sockets 132 of the connector tower 130 having a 3D printed connection surface to facilitate the user's configuration of the modular components to the connector tower 130. The casters 116 can be electromechanically controlled during operation of the robot (e.g., as a “Move” module, discussed below) according to one embodiment of the disclosure herein.

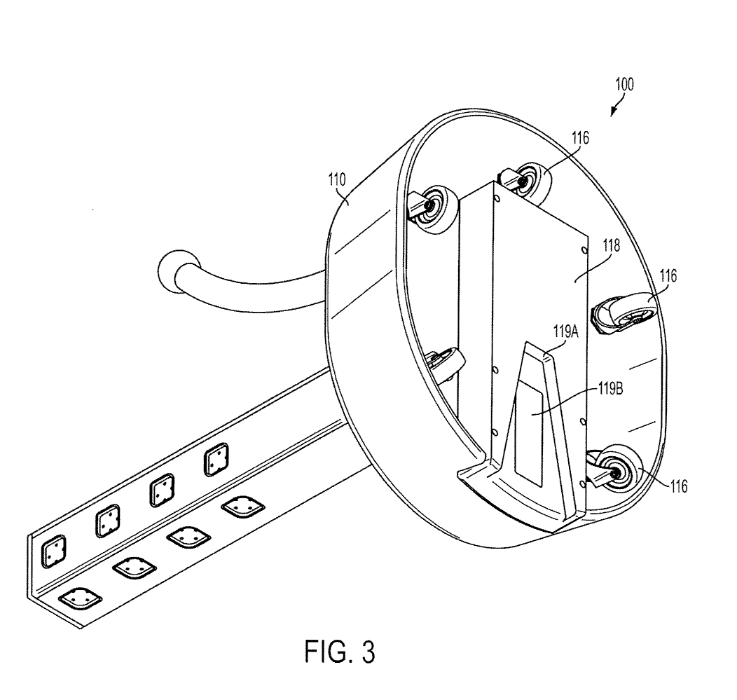

FIG. 3 illustrates an underside view of the robot base unit according to the exemplary embodiment of the present disclosure. In the exemplary embodiment, five casters 116 are provided to facilitate the 360° movement of the robot base unit 100. In addition, a battery housing 118 is provided for the robot. The battery housing 118 includes battery charging contact 119A and a flat steel plate 119B secured to the upper surface of the battery charging contact 119A to facilitate an electromagnetic connection with a robot docking station during recharging, as will be discussed in detail below.

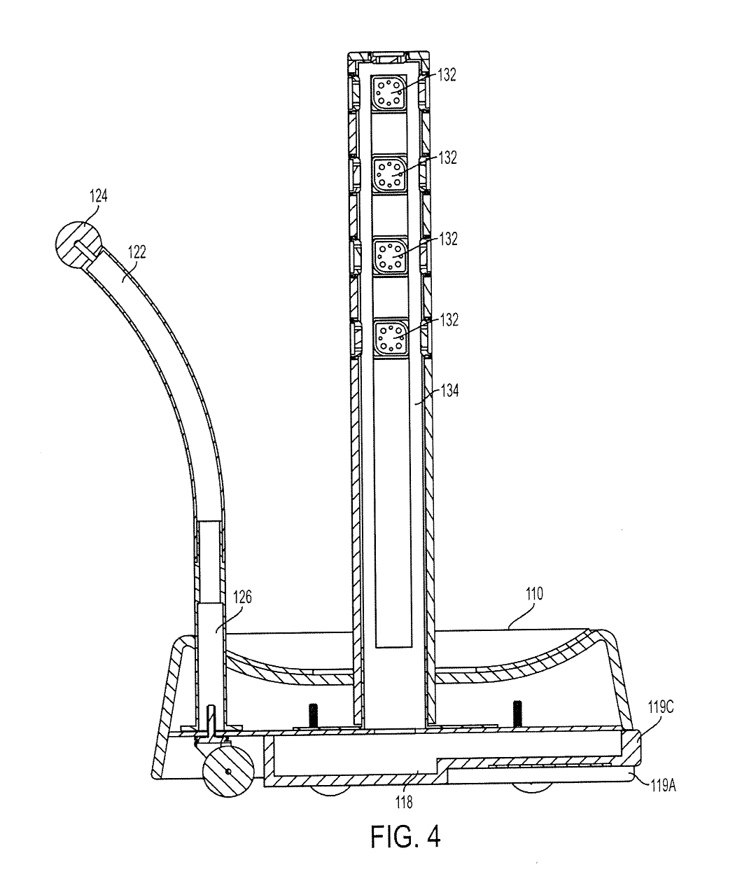

FIG. 4 illustrates a detailed side view of the robot base unit 100 according to the exemplary embodiment of the present disclosure. As shown, the base platform 110 includes the battery housing 118 and battery charging contact 119A. In addition, a rubber bumper 119C is provide to protect the battery charging contact 119A during movement of the robot if the front of the robot base unit 100 were to crash into a wall or similar structure. The tubular handle 120 includes the extended tubular arm 122 and a tubular base 126 that is mounted or secured to the base platform 110. In the exemplary embodiment, the extended tubular arm 122 and a tubular base 126 are coupled to each other using a bolted slip joint assembly as would be appreciated by one skilled in the art. Furthermore, the circular shaped handle 124 can comprise a milled flat pool ball with a threaded stud pin to be secured to a stud extending from the tubular arm 122 in the exemplary embodiment. As further shown, the connector tower 130 includes a metal frame 134 with the plurality of connector sockets 132 mounted therein. As will be discussed below, the modular components of the robot are input and output blocks that can be magnetically secured to the plurality of connector sockets 132 of the connector tower 130. Using the magnetic coupling with the connector sockets 132, the modular components can be powered for operation. Alternatively, wires can be extending from the power source (i.e., the battery) to each of the connector sockets 132. Preferably, the modular components are configured to automatically correct for reverse polarity of the user inadvertently couples the components in an incorrect orientation. In one refinement of the exemplary embodiment, the metal frame 134 serves as the electrical connection between the connector sockets 132 and a battery secured in the battery housing 118 of the base platform 110 to effectively power the modular components. In an additional embodiment, the metal frame 134 includes a plastic covering (not shown) or other non-conductive material to serve as an insulator for the metal frame 134.

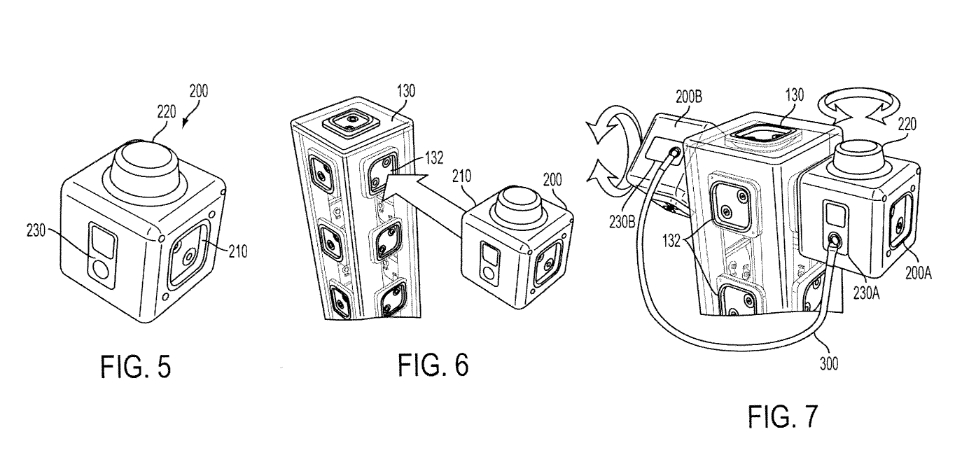

FIG. 5 illustrates a perspective view of a robotic modular component 200 (interchangeably referred to as a “block” or “modular block” herein) according to an exemplary embodiment of the present disclosure. In the exemplary embodiment, it is contemplated that there are input modular components and output modular components. As shown, the modular component 200 generally comprises a square shaped frame and includes one or more magnetic coupling members 210 that facilitate coupling to the connector tower 130 and/or one or more additional modular components. Although not shown in FIG. 5, the magnetic coupling members 210 can including a projecting member or the like that is designed to structurally fit into a connector sockets 132 of the connector tower 130. Although the connection between the modular component 200 and the connector socket 132 is magnetic, the physical alignment between the projecting member and the coupling socket helps the user properly position the modular component.

As further shown in FIG. 5, the modular component 200 can include one or more input members 220. In this embodiment, the input member 220 is shown to be an exemplary rotational knob. However, it is contemplated that the input member can include any type of sensor or actuator, including, but not limited to: a pushbutton, a toggle switch, a rotational knob, a sensor (such as a visual/light or fluid sensor), a microphone, a proximity sensor, a speed sensor, a motion sensor, a touch or force sensor, a gyrometer, or the like. As will be discussed below, the user is provided with multiple types of input modular components with various input members that collectively enable the user to customize the functionality and design of the robot. In addition, the modular component 200 includes one or more connection ports 230 that enable a cable connection to other modular components connected to the connector tower 130.

FIG. 6 illustrates an exemplary coupling between the input modular component 200 and connector tower 130 of the robot base unit 100. In the exemplary embodiment, a user can secure the modular component 200 to the connection tower 130 by inserting the magnetic coupling members 210 in the direction of the arrow to the connector socket 132 of the connector tower 130. Once the two objects reach a certain distance from one another, the components will couple via a magnetic connection. Applying a force in the opposite direction will quickly remove the modular component 200 from the connector tower 130, which enables the user to quickly customer and change the configuration of the robot.

FIG. 7 illustrates an exemplary embodiment of the connector tower 130 with input and output modular components coupled thereto in accordance with an exemplary embodiment. As shown, an input modular component 200A is coupled to a first connector socket 132 of connector tower 130 and an output modular component 200B is coupled to a second connector socket 132 of connector tower 130. As noted above, both modular components 200A, 200B are powered by connector tower 130 extending from a battery housed in the battery housing 118 of the base platform 110. Although the connection between modular component 200B and the connector tower 130 cannot be seen, it is contemplated that magnetic coupling member 210 of modular component 200B includes a rotational mechanical member (e.g., an electromechanically controlled wheel) that enables the modular component 200B to rotate in clockwise and counterclockwise directions relative to the connector tower 130. It should be appreciated that the modular component 200B, which is described as a rotational arm, is an exemplary embodiment of an output modular component. It is contemplated that the modular robotic system described herein can implement many types of output components that perform some type of action. These output modular component can include (without limitation): movement components, lighting (e.g., turning and rotation) components (e.g., LEDs), a fan, additional magnetic components, a speaker, a mechanical hand or other gripping member, components with physical attributes (e.g., a hand, face, torso, etc. for the robot) or the like.

To implement the operation and functionality of the modular components 200A, 200B, the user can connect a single cable connector 300 from the signal connection port 230A of modular components 200A to the signal connection 230B of modular components 200B. Although only two modular components are shown (i.e., input block 200A and output block 200B), it is contemplated that any input modular component can be connected to any output modular component for dynamic and user configurable control. As will be described in detail below, each modular component includes a processor or processing chip and each component is programmed to have a communication protocol. Cable connector cable 300 is advantageously a single cable connector that enables bidirectional serial communication between the two connected modular components. Preferably, the communication connector cable 300 consists of a single conductor high flex silicon wire with two spherical allow ends. The spherical ends allow the communication wire to magnetically attach to connection ports 230 at any angle, and maintain contact as the module containing the port rotates or moves in any direction.

Based on the respective communication protocols of the two blocks (i.e., the input and output modular components) can communicate with each other including identifying their functionality/operation, query the status of the connected partner, and operate accordingly. For example, if input modular component 200A is the exemplary block illustrated FIG. 5 that includes an input member 220 as a rotational knob, block 200A will communicate its functionality and status to block 200B, which can be a rotational mechanical arm as described above, for example. Block 200B will likewise communicate its functionality and status back to block 200A. Once bidirectional communication is established between block 200A and block 200B via cable connector 300, the modular components can operate in conjunction with each other. For example, if a user rotates the input member 220 (i.e., the rotational knob) of block 200A, the status of the knob will be communicated to block 200B, which will in turn rotate in a responsive clockwise or counterclockwise direction via the rotational mechanical coupling to connector tower 130.

It should be appreciated that conventional data communication for similar robotic systems requires a data bus of multiple wires for data reception and transmission between components. For example, such communication requires a minimum of three wires (common ground, transmitting line, and receiving line) to form a simple serial communication bus. This design makes cable arrangement extremely cumbersome and inefficient when dealing with many multi-conductor cables between multiple robot modules.

In contrast, the system disclosed herein utilizes a cable connector 300 that is a single-wire bi-directional mechanism that provides the communication method for all the input and output modules as well as the control or brain module, which will be described below. By using only one wire per each connecting pair, a single-conductor non-polarized cable connection is provided. In the exemplary embodiment, cable connector 300 utilizes half duplex communication with data collision and transmission direction managed by the firmware of the connected modules. Serial communication data is both received and transmitted into and out of the signal connection port 230 of the modular components bi-directionally. Thus, cable connector 300 enables the modular components to each identify and query that status of the respective connected module component.

It is reiterated that the foregoing blocks 200A and 200B are provided merely as an example of the modular robotic system. However, it should be understood that both modular components can have alternative operation/functionality. Regardless of the specific blocks connected to one another, the communication protocol between the two blocks will enable them to synchronize operation with one another accordingly. Such dynamic interchangeability provides the user with user-specific customizable design and configuration for the robotic system.

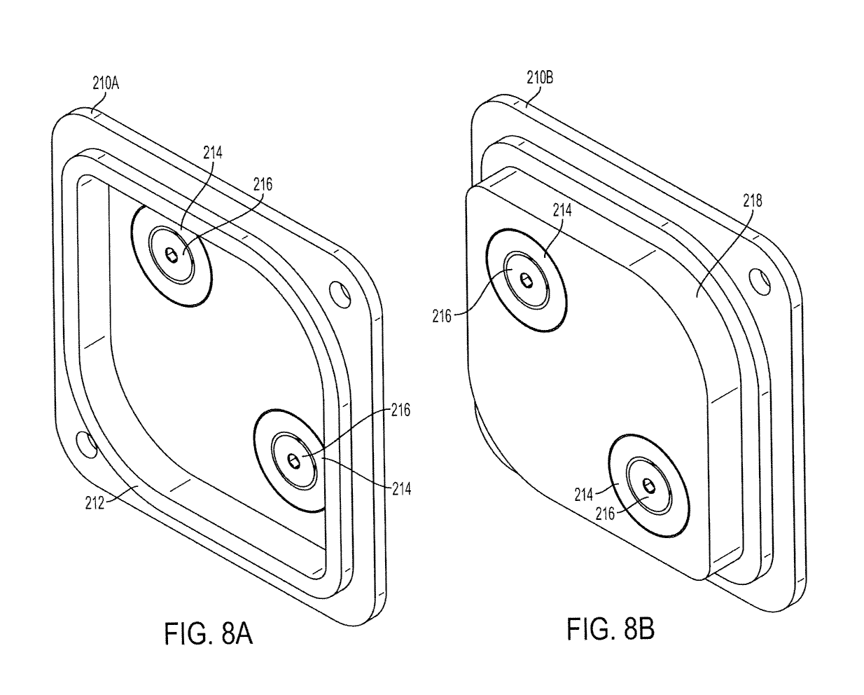

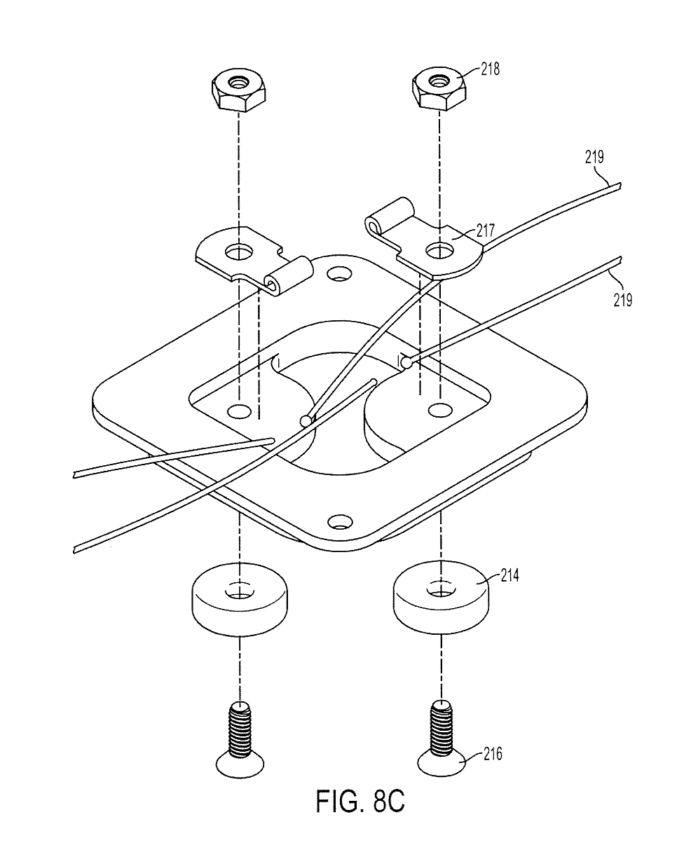

FIGS. 8A-8C illustrate magnetic coupling members according to an exemplary embodiment of the present disclosure. As shown in FIG. 8A, magnetic coupling member 210A includes a recessed coupling connection 212 that includes a pair of countersunk magnets 216 secured to the block by a pair of screws 216. Similarly, in FIG. 8B, magnetic coupling member 210B includes a projecting coupling member 218 that also includes a pair of countersunk magnets 216 secured to the block by a pair of screws 216. As noted above, the projecting coupling member 218 can be manufactured with dimensions to be fitted into connector socket 132 of connector 130 of the robot base.

FIG. 8C illustrates an expanded view of magnetic coupling member 210B illustrated in FIG. 8B. As shown, the pair of countersunk magnets 216 are secured to the block by a pair of screws 216 with respective flag terminals 217 and nuts 218. Moreover, a pair of electrical wires 219 can be coupled to the respective countersunk magnets 216, electrically coupling them to the other hardware component of the block.

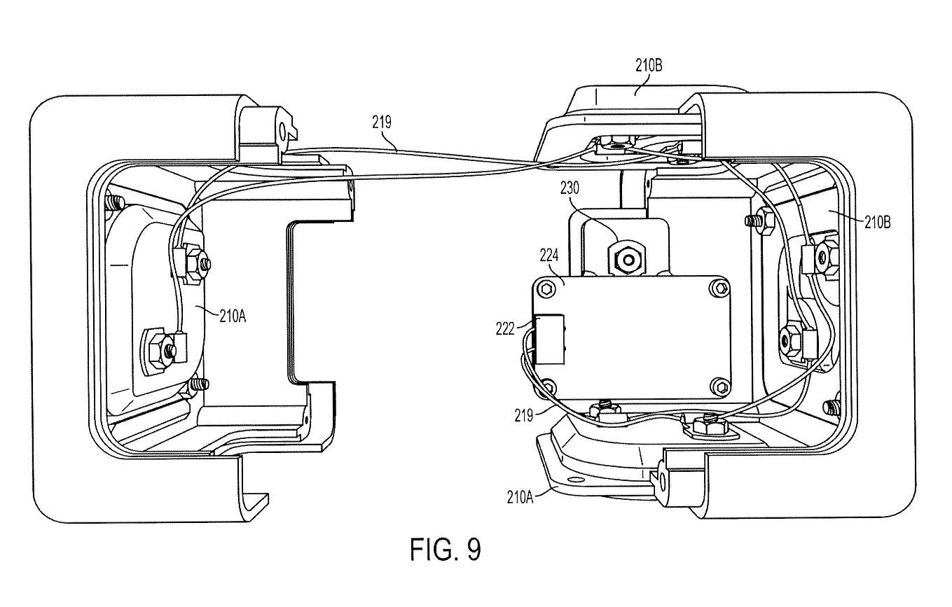

FIG. 9 illustrates an expanded view of a modular component according to an exemplary embodiment of the present disclosure. As shown, the modular component 200 includes a square shaped frame configured to house a pair magnetic coupling members 210A and a pair magnetic coupling members 210B. As shown, the electrical wiring 219 electrically connects each of the magnetic coupling members 210A and 210B and is ultimately coupled to a pigtail connection 222 attached to a printed circuit board 224. In the exemplary embodiment, the printed circuit board 224 includes a processor element or chip (not shown) secured thereto that is configured to process the signals received from or output to the signal connection port 230. More particularly, if the modular component is an input block, for example, the processing element is configured to receive the input signal from the input member 220 (as shown in FIG. 5, for example, not shown in FIG. 9) and output a command/control signal via signal connection port 230, which is an output port in the instance that the modular component is an input block. The signal connection port 230 is communicatively coupled to the processing element secured to printed circuit board 224 by any standard communication means. In the exemplary embodiment, signal connection port 230 comprises a NIB disc magnet in a cup with a communication wire (not shown) wired to the printed circuit board 224. Further, By providing electrical wiring between each of the magnetic coupling members 210A and 210B and the pigtail connection 222, the design of the modular component ensures that the processing element will receive power from the connector tower 130 of the robot base 100, regardless of which magnetic coupling member is actually secured to a connector socket 132 of the connector tower 130.

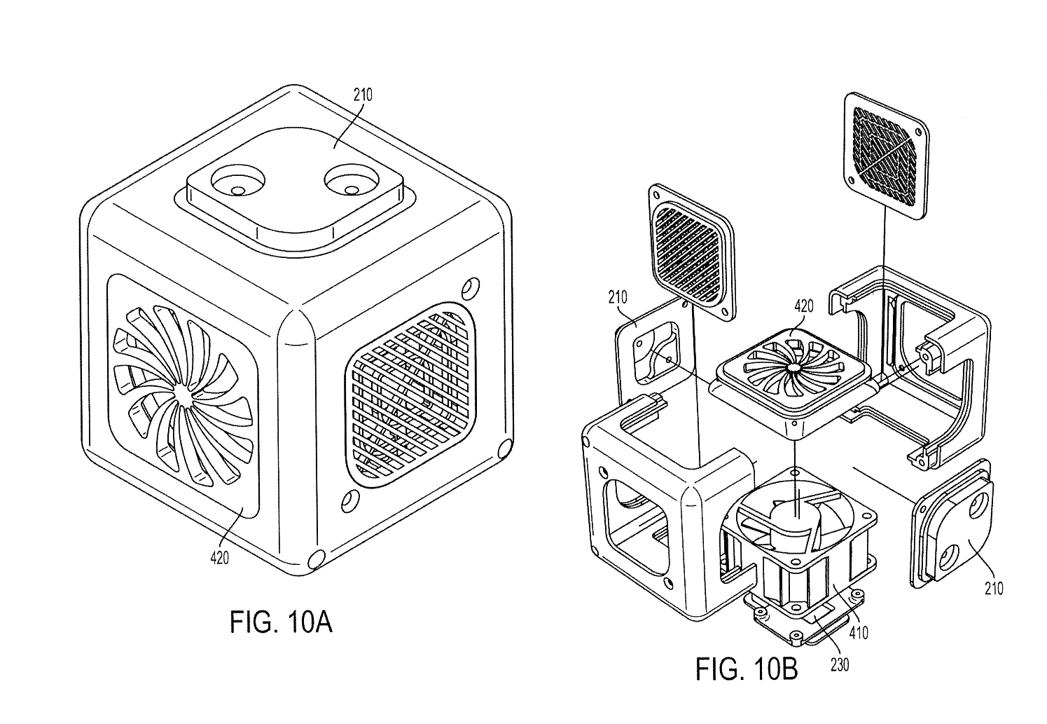

FIGS. 10A and 10B illustrate a fan module 400 according to an exemplary embodiment of the present disclosure. Fan module 400 is another exemplary modular component that is configured to be coupled to connector tower 130 of the robot base unit 100 by either magnetic coupling member 210. In particular, as shown in FIG. 10B, input connection port 230 is provided and configured to receive a control signal to turn on fan unit 410, for example. Fan unit 410 will then blow air through fan cover 420, which is secured to the frame of fan module 400. It should be understood that fan module 400 is shown for illustrative purposes, but is not require to for a user to operate the customizable robotic system disclosed herein.

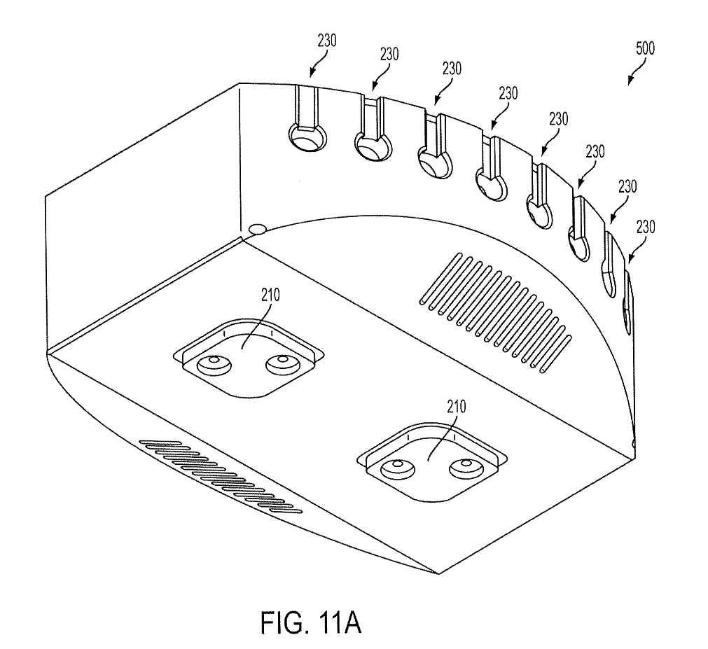

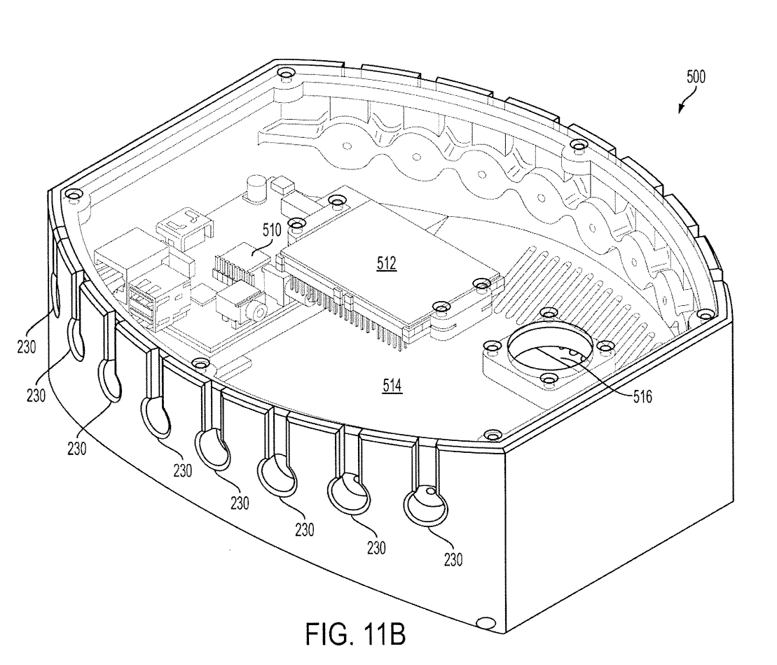

FIGS. 11 A and 11B illustrates a control modular component 500 according to an exemplary embodiment of the present disclosure. The control modular component 500 (also referred to as a “brain module” or “control module”) is similar in design to the modular component 200 illustrated in FIG. 5 in that it can be easily coupled and decoupled from the connector tower 130 of the robot base 100 by a magnetic coupling members 210. One distinction in the exemplary embodiment is that the control modular component 500 includes two magnetic coupling members 210. Accordingly, when the control modular component 500 is coupled to the connector tower 130, the magnetic coupling members 210 will be connected to two adjacent sockets 312 of connector tower 130. In addition, the control modular component 500 includes a plurality of connection ports 230. Each connection port is provided to connect the control modular component 500 to a modular component 200 (either an input module or output module) using a connector cable 300.

FIG. 11B illustrates the internal circuitry control modular component 500 according to an exemplary embodiment of the present disclosure. As shown, the internal circuitry includes a processor 510, an LCD screen 512, an I/O co-pilot board 514, and a programming connector 516. The specific functionality of these electronic components should be understood to one skilled in the art and will not be described in detail herein, however, it should be appreciated the processor 510 of the control modular component 500 is configured to execute the customized computer program designed by the user. In particular, each of the connection ports 230 is communicatively coupled to the internal circuitry to transmit and receive data from the other module components 200 coupled to the control modular component 500. Moreover, as will be discussed in detail below, the control modular component 500 can be patched to a programming station and the electronic memory can be loaded with a customized program for the robotic system.

In addition, the control module 500 includes electronic memory that is capable of electronically storing a computer program as would be understood to one skilled in the art. For instance, the memory can include read a memory chip such as random access memory or RAM, read only memory or ROM, erasable programmable read only memory or E-PROM, electrical erasable programmable read only memory or EE-PROM, a rewriteable card-type read only memory such as a smart card, a magnetic tape, a hard disc, and any other suitable means for storing a program therein. Furthermore, a processor is provided to execute the customized program designed by the user. The processor can be any suitable processor cable of executed a program on the memory for controlling the modular components attached to the control module, including, but not limited to a microprocessor, a programmable logic device, an application specific integrated circuit, or the like. Programming the control module will be discussed in detail below. In the exemplary embodiment, LCD screen 512 is provided to display active connections of the control module 500 to connected modular components. For example, when a user plugs in a connection wire to a connection port 230, the screen 512 will indicate this connection. It should be understood that alternative information relating to the functionality and connections of the control module 500 can also be displayed on screen 512.

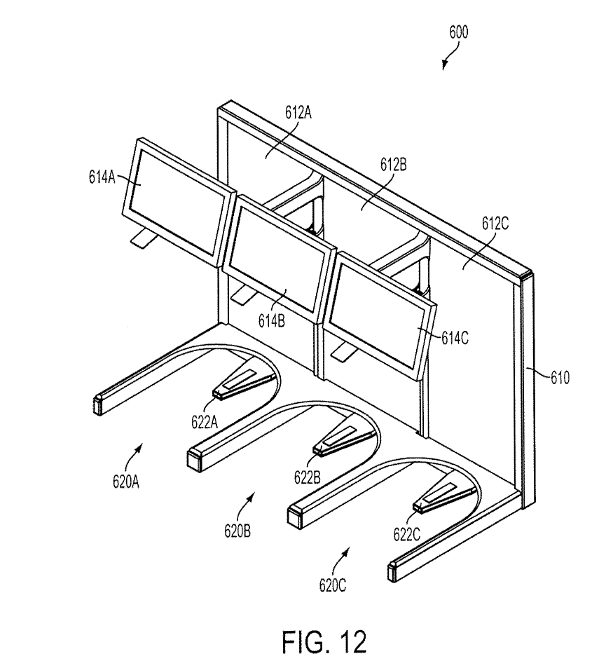

FIG. 12 illustrates a docking or “check out” station 600 according to an exemplary embodiment of the present disclosure. The docking station includes a frame 610 that includes three reception areas 620A, 620B and 620C. The reception areas 620A, 620B and 620C are each designed to receive a respective robot base unit 100. Each reception area 620A, 620B and 620C includes a power transmission unit 622A, 622B, and 622C, which are designed to receive the battery charging contact 119A of the battery housing 118 of the robot base unit 100. Specifically, the flat steel plate 119B of the battery charging contact 119A is juxtaposed next to the power transmission unit 622A when the robot base unit 100 is positioned in reception area 620A to facilitate electromagnetic connection for recharging. Although not shown, it should be appreciated that the power transmission unit 622A include the necessary hardware to perform the recharging of the batteries of the robot base units 100.

As further shown, the frame 610 holds a plurality of back panels 612A, 612B, and 612C and a plurality of monitors 614A, 614B, and 614C. The back panels 612A, 612B, and 612C are provided to give the user a status indication for the respective robot base unit positioned in the reception area. For example, if the robot base unit is fully charged, the back panel may be green, whereas it may be red if the robot base unit needs further charging.

Furthermore, the monitors 614A, 614B, and 614C are configured to provide the user with information regarding the robot system. For example, the monitor can provide a challenge to the user for the construction the robot, for example, “Can you create a robot that would make a sick child laugh?” Alternatively, if the specific robot is not operable (e.g., not full charged), the monitor may provide instruction, such as “Please go to another station.” The monitor can also provide information to the user regarding how to check out and use the robot or the like. It should be appreciate that the monitor can be any conventional computer, tablet, or the like, that is capable of providing a graphical user interface.

FIG. 13 illustrates a build station 700 according to an exemplary embodiment of the present disclosure. The build station 700 is provided to house the modular components for the user to select to customize the user's robot. The build station 700 includes a frame 710 having a plurality of columns 720 that can magnetically hold the modular components. A monitor 730 is provided on the side of the frame 710. The monitor 730 is configured to provide information about the modular components. In particular, the user can sign on to the monitor and then plug (magnetically) a modular component by the input port to a receiving input 740 communicatively coupled to the monitor 730. The monitor is capable of querying and identifying the modular component and providing a describing of the functionality and the like of the attached modular component to the user. In this manner, the user can check many modular components in order to indentify their respective functionality and chose the desired components to customize his or her robot.

FIG. 14 illustrates a programming station 800 according to an exemplary embodiment of the present disclosure. The programming station 800 includes a table 810 and a multi-touch user input screen 820. The programming station is provided to create and customize an operation program for the brain module and, therefore, includes all necessary hardware components including a processor, electronic memory, and the like to generate and execute a computer program. In the exemplary embodiment, a user can tag in and plug in a robot, and, in particular, the brain module, for advanced programming. The programming station 800 can be communicatively coupled to the brain module by cable connector 300 (not shown in FIG. 14) or by any other conventional data communication mechanism, including a USB connection cable or the like. Once the brain module is communicatively coupled to the programming station 800, the programming station will query the brain module to identify which input and output modules are connected to the brain module. The processor of the programming station 800 is configured to cause the input screen 820 to display the input and output modules to the user, which will enable the user to customize their operational relationship as discussed below. If the user attaches additional components to the robot base unit, the new components will also be immediately displayed on the input screen 820. In addition, physical blocks placed on the table can be used to facilitate advanced coding of the user's customized operational program. Furthermore, the programming station 800 enables users to run a simulation of the customized program or have the program directly on the robot. The program can be saved and/or shared with other users.

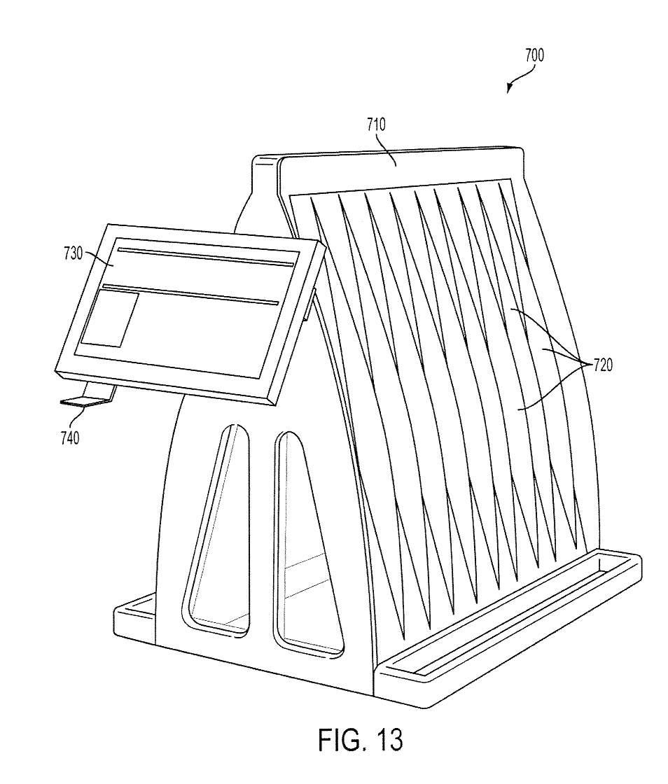

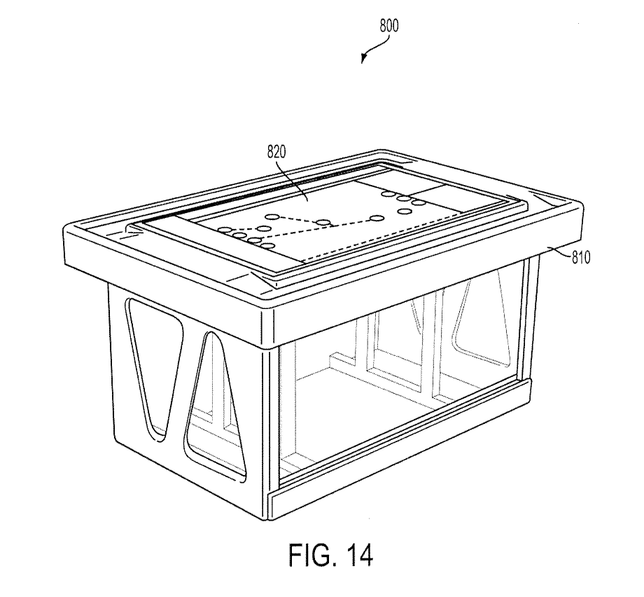

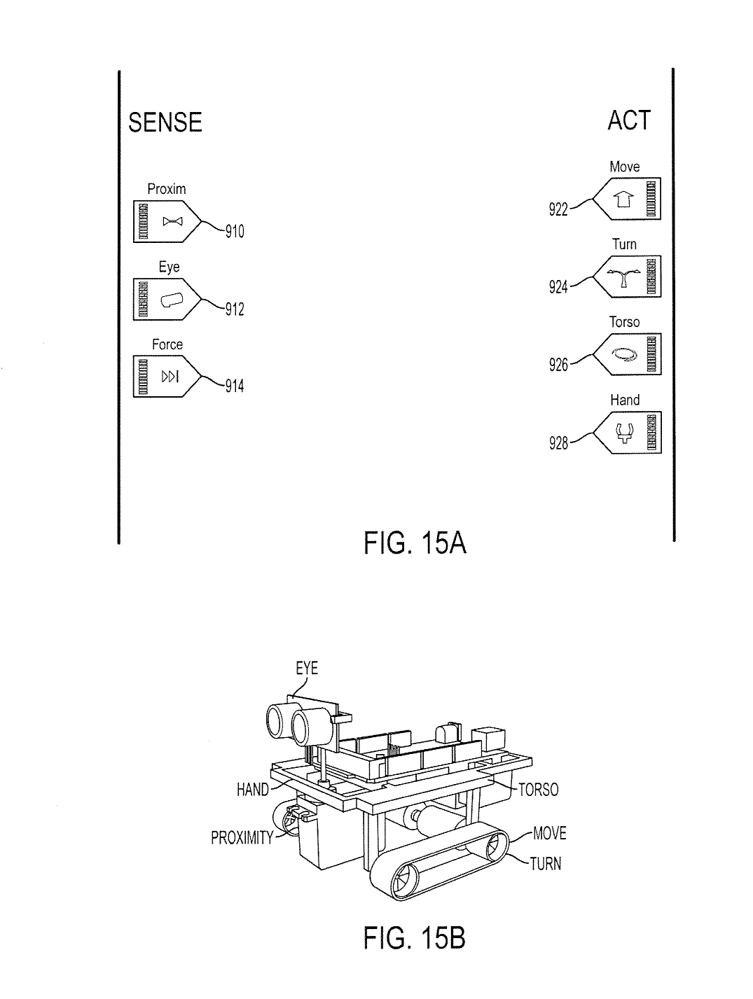

As noted above, there are two types of physical modular components: input modules and output modules. FIGS. 15A and 15B provide a visual depiction of icons for exemplary input and output modules according to an embodiment of the present disclosure. In particular, FIG. 15A illustrates three exemplary input or “Sense” modules, which include a proximity sensor (“Proxim”) 910, a visual sensor (“Eye”) 912, and a contact sensor (“Force”) 914. FIG. 15B illustrates a visual depiction of a robot (not to be confused with the exemplary robot of the system described herein) that includes an eye sensor that can detect visual objects and a proximity sensor that can detect objects in close proximity (e.g., two inches) from the robot. Although not shown, a Force sensor can be provided to detect when the robot actually contacts another object (e.g., a wall or stair).

Referring back to FIG. 15A, four output or “act” modules include “Move” 922, “Turn” 924, “Torso” 926 and “Hand” 928 modules. Again, FIG. 15B illustrates exemplary implementations of these types of sensors. It is reiterated that the input and output modules are provided only for exemplary embodiments, but alternative functioning modules can be provided.

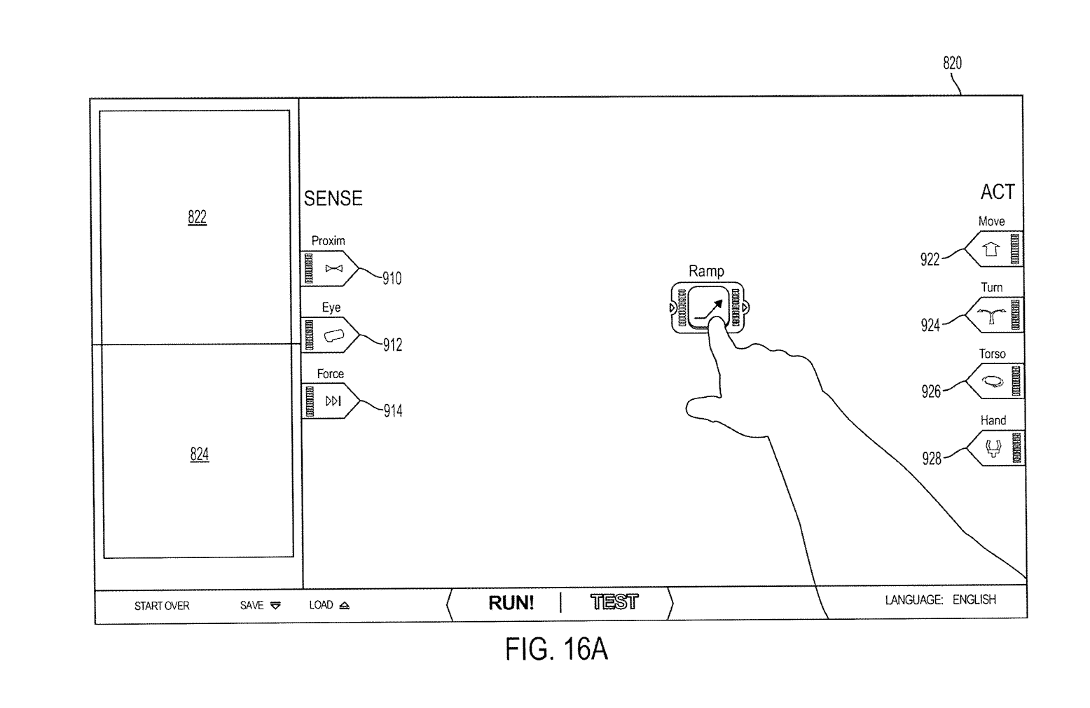

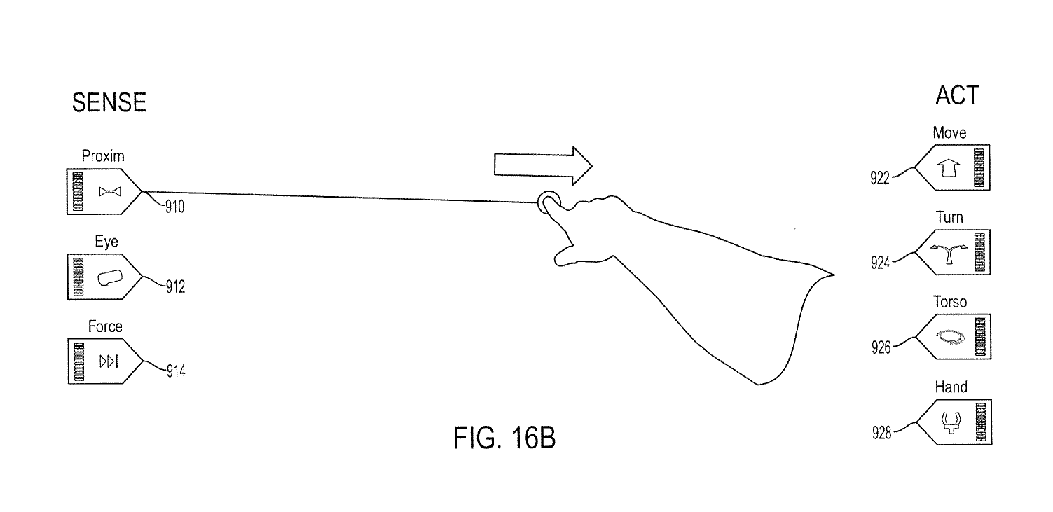

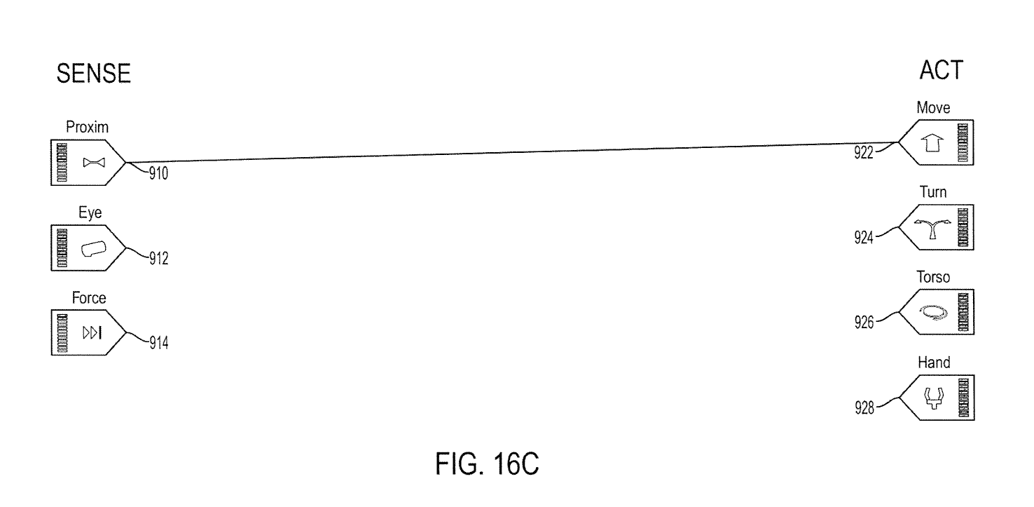

FIGS. 16A-16C illustrate input screen 820 that includes a plurality of icon according to an exemplary embodiment of the disclosure herein. As noted above, once the brain module is communicatively coupled or “patched” to programming station 800, the programming station will query and identify the brain module to determine the input and output (or “sense” and “act”) modules that are coupled to the brain module. FIG. 16A illustrates that the “Proxim” 910, “Eye” 912 and “Force” 914 sensors are coupled to the brain module and also that the “Move” 922, “Turn” 924, “Torso” 926 and “Hand” 928 modules are coupled to the brain module. Additional user options including “Start Over”, “Save”, “Load”, “Run!”, “TEST” and a language option are provided on the input screen 820. It should be understood that these additional options are provided for the users testing, loading, saving of the customized operation programs for the robotic system that he or she is designing. In addition, input screen 820 can include a plurality of information panels to facilitate user operation. For example, panel 822 can be an Overview panel that provides high level messaging/instruction including initial instructions on how to begin, what to do, and the like, in a user-friendly manner. In addition, panel 824 can be a Component Detail panel that provides detail on the component in focus that the user may be considering when customizing the operation program for the robotic system. This information would include a functional description of the component and the editable parameters that will be discussed in detail below.

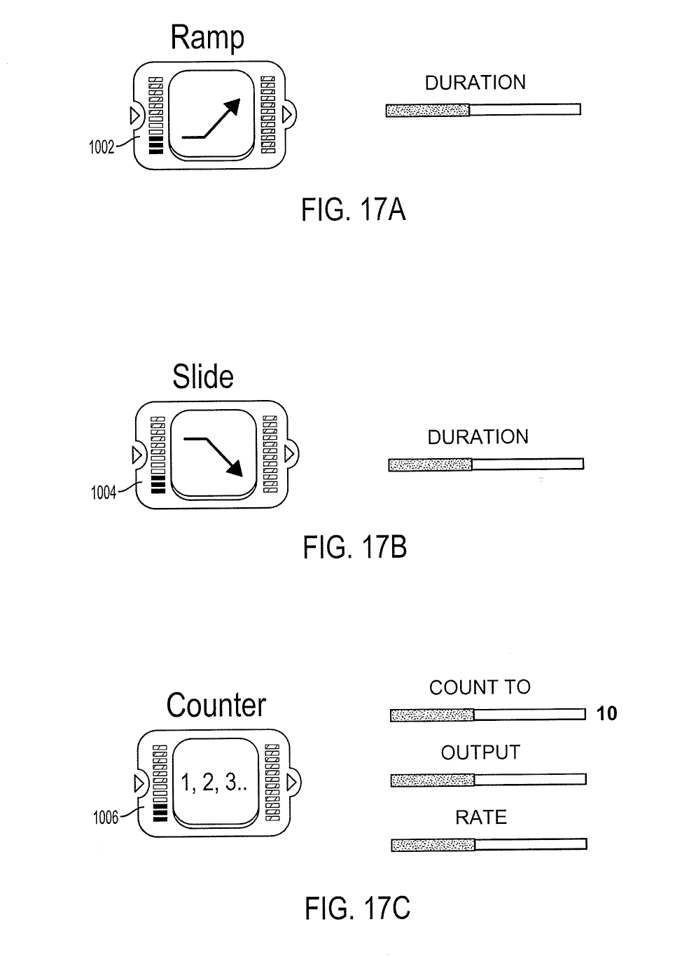

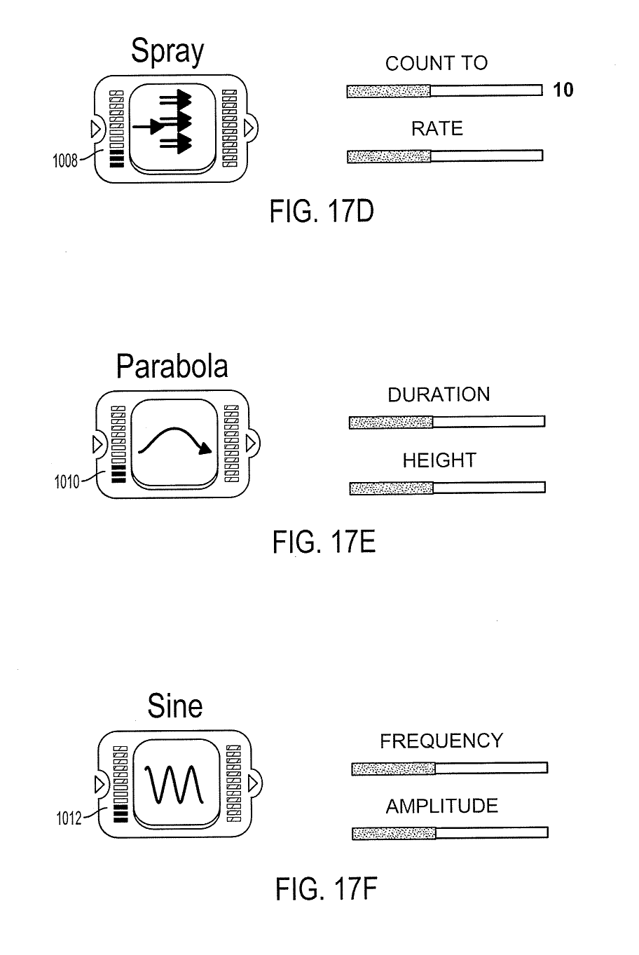

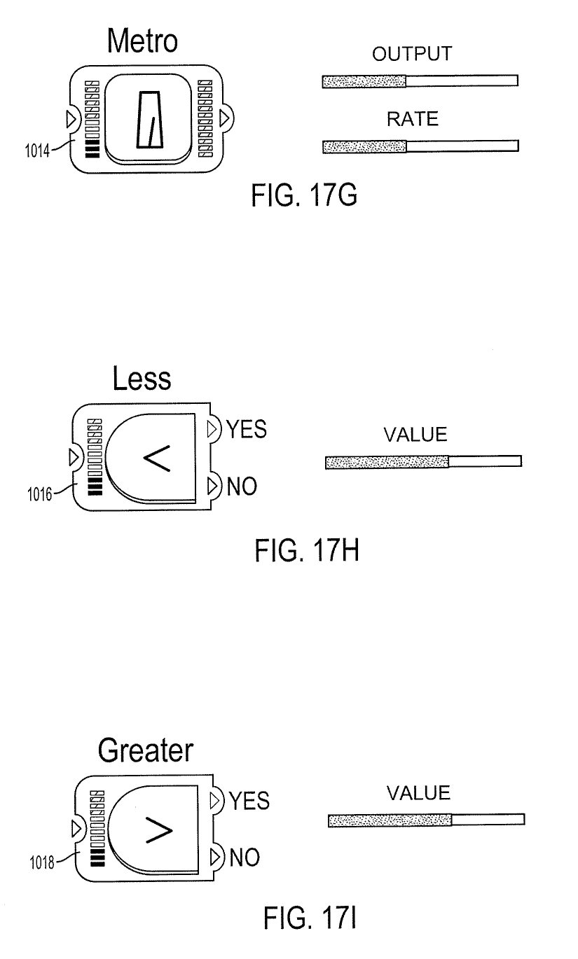

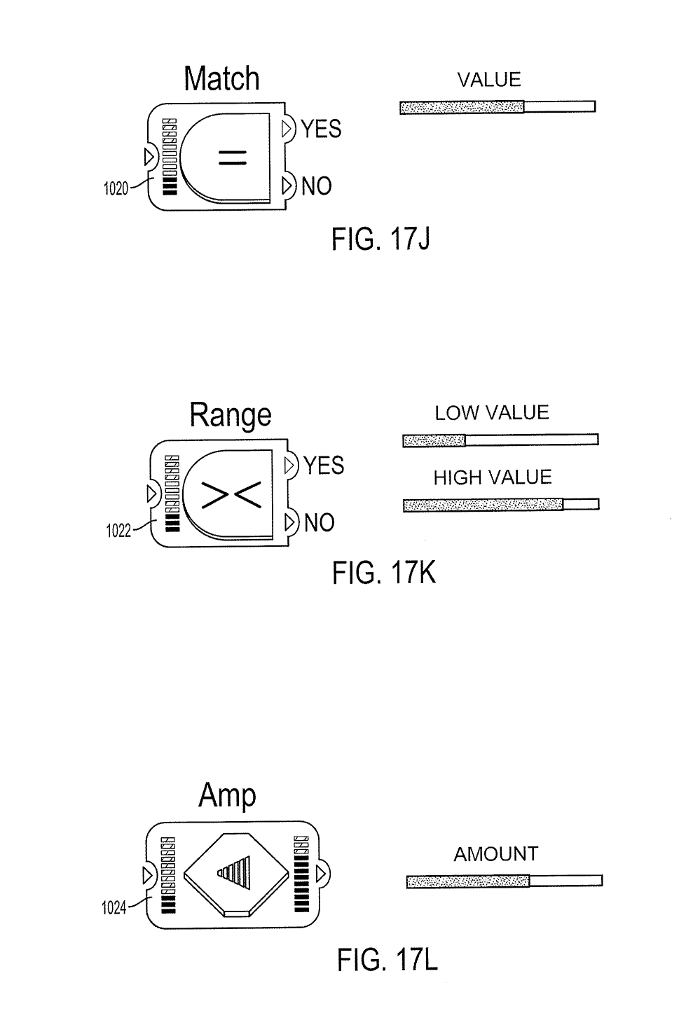

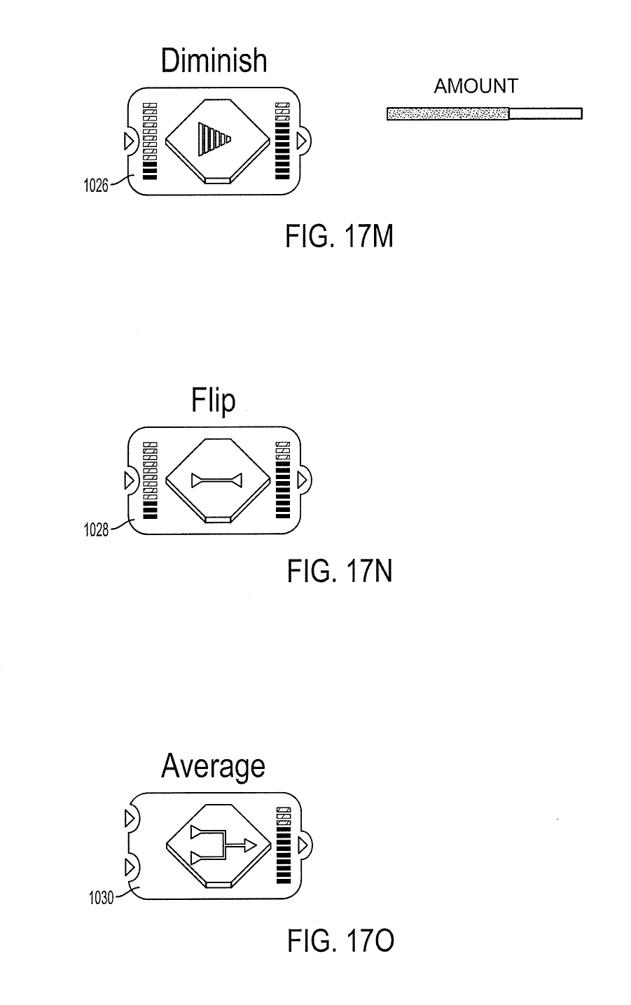

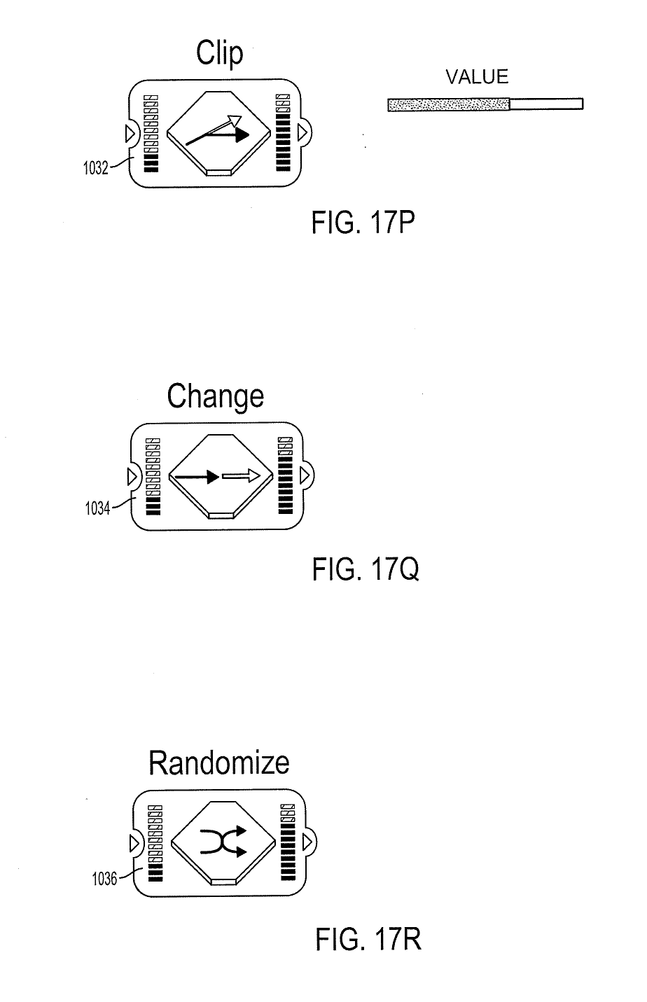

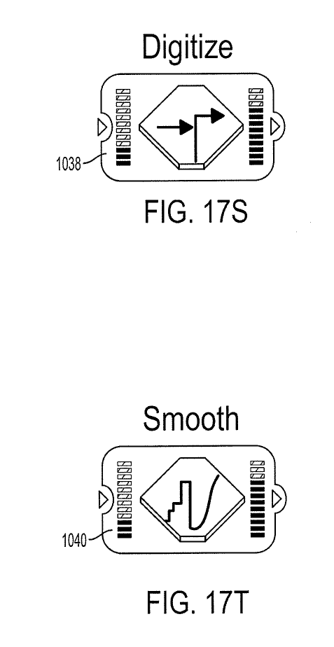

Input screen 820 is provided as a software based application that enables any user to easily program the functionality of the brain module, and, therefore, the input and output modules connected to the brain module. Using input screen 820, users can program more advanced and complicated behaviors using a simply multi-touch interface. As shown in FIG. 16A, a user can drag an intermediary module (e.g., the “Ramp” icon) between the “Sense” and “Act” icons and drag connectors between the different components to customize and define an operational relationship between the modules. In the exemplary embodiment, a plurality of blocks are provided with graphical icons (i.e., fiducial markers) representing the different intermediary modules, which are described below with respect to FIGS. 17A-17T. Furthermore, the input screen 820 is provided with a plurality of cameras integrated into the touchscreen that are configured to identify the fiducial mark facing the touchscreen. The cameras read the fiducial marker and communicate is identification to the processing unit of the programming station 800, which in turn adds the intermediary module the customized program that the user is building. As will be discussed below, the user can then drag connections between the different icons using the input screen 820. It should be appreciated that in an alternative embodiment, the intermediary modules can be displayed to the user as a software based list on the input screen 820, enabling the user to select the desired intermediary module by a simple point and click operation.

FIGS. 16B and 16C illustrate user operation of the input screen according to an exemplary embodiment of the disclosure herein. As shown in FIG. 16B, a user can use the touch interface of input screen 820 to drag a line from a Sense icon (e.g., the “Proxim” icon) towards the Act icons. FIG. 16C illustrates the completed connection from the “Proxim” icon or sensor to the “Move” module. After the program is finalized by the user, the programming station 800 will program the brain module to perform the customized program during operation. In this example, the robot will be programmed to move a certain distance (e.g., 1 foot backwards) if the proximity sensor (i.e., “Proxim” sensor) detects an object within another distance (e.g., 1 inch) of the robot. It should be appreciated that the example disclosed in FIGS. 16B and 16C is a simplistic example provided for illustrative purposes, but that the programming station enables a user to customize significantly more sophisticated operational programs for the robot as will be discussed below.

As described with respect to FIGS. 15 and 16, the programming station illustrates icons for physical modular components connected to the brain module (e.g., the Sense and Act sensors). In addition, the exemplary system provide a plurality of intermediary modules (either by positioning block with fiducial markers or selecting software icons) that the user can utilize during customized programming to define the relationship between physical components. In application, the intermediary modules are software components loaded into the customized operational program that can be categories into three types of components: “Generate”, “Compare” and “Transform”. Generate components provide software based time patterns that make tools that will create events over time. For example, the “Ramp” component discussed above generates a series of values from 0 to 1 when triggered. Compare components are logic modifiers that can be used to interrupt to modify the flow of information between components. For example, a “Less Than” component can split the signal of data at a given value. Finally, transform components can transform an incoming value. For example, a “Delay” transform causes values passing through the component to pause for a certain time period (e.g., five seconds).

FIGS. 17A through 17T illustrate exemplary icons representing the intermediary modules (also referred to as “software components”) according to an exemplary embodiment of the disclosure herein. In particular, FIGS. 17A-17C illustrate icons for software components “Ramp” 1002, “Slide” 1004 and “Counter” 1006, respectively. As noted above, the “Ramp” 1002 module generates a series of values from 0 to 1 when triggered. In particular, an input greater than 0.5 triggers (see incoming activity meter in left column of icon) an upward stream of values from 0 to 1. The stream will continue until complete. If the input threshold is passed while the ramp is in process it will be disregarded. The threshold indicates the point at which the ramp will be triggered and the duration is the amount of time it will take to go from 0 to 1. In contrast, the “Slide” module 1004 will trigger a downward stream of numbers from 1 to 0 when the input exceeds 0.5 triggers. Again, the stream will continue until complete. If the input threshold is passed while the slide is in process it will be disregarded. The threshold indicates the point at which the slide will be triggered and the duration is the amount of time it will take to go from 1 to 0. The “Counter” module 1006 will send a designated value (i.e., output) out for a set number of times (e.g., 1 to 10) at a set interval (i.e., rate) when the input exceeds 0.5 triggers. The stream will continue until complete. If the input threshold is passed while the count is in process it will be disregarded.

FIGS. 17D-17F illustrate icons for software components “Spray” 1008, “Parabola” 1010 and “Sine” 1012, respectively, according to an exemplary embodiment of the disclosure herein. The Spray 1008 module triggers a counter that will send a designated value out for a set number of times (i.e., “count to”) at a random intervals (i.e., “rate”) within a range when the input exceeds 0.5 triggers. The stream will continue until complete. If the input threshold is passed while the count is in process it will be disregarded. The Parabola module 1010 triggers a curved sequence of numbers starting at 0, fading up to a specified value (i.e., “height”) then fading back down to 0 when the input exceeds 0.5 triggers. The stream will continue until complete. If the input threshold is passed while the parabola is in process it will be disregarded. The threshold indicates at which point the parabola will be triggered and the “duration” is the amount of time it will take to go from start to finish. The Sine module 1012 outputs a continuous value as long as the input exceeds 0.5 triggers. The value will be informed calculated as a sine wave with the result ranging from 0 to the “amplitude”. “Frequency” will control the duration between 0 point crossing.

FIGS. 17G-17I illustrate icons for software components “Metro” 1014, “Less” than 1016 and “Greater” than 1018, respectively, according to an exemplary embodiment of the disclosure herein. The Metro icon 1014 will generate a series of values at a specified “rate” when an input is past a certain threshold. The amount of the value is set by the “output”. For the “Less” than module 1016, if an input is less than a specified value then the output will be sent through as “YES”, otherwise it will be sent through “NO”. Similarly, for the “Greater” than module 1018, if an input is greater than a specified value then the output will be sent through “YES”, otherwise it will be sent through “NO”. In the exemplary embodiment, for comparison icons such as the “Greater” than or “Less” than icon, the input value is compared with a set value that can be predetermined or determined by the user. It should be understood that for alternative embodiments, the comparison modules can compare two input values or the like.

FIGS. 17J-17L illustrate icons for software components “Match” 1020, “Range” 1022 and “Amplify” 1024, respectively, according to an exemplary embodiment of the disclosure herein. The Match module 1020 outputs a “YES” value if an input is equal to a specified “value”, and, otherwise, outputs a “NO” value. The Range module 1022 will output a “YES” value if f an input falls within a specified range, and, otherwise, will output a “NO” value. For the Amplify module 1024, any input will be boosted by a set amount. This will be the simple multiplication by a value between 1 and 2, for example. Preferably, results cannot be greater than 1. For example, an input of 0.2 and an amount of 1.5 (0.2*1.5=0.3).

FIGS. 17M-17O illustrate icons for software components “Diminish” 1026, “Flip” 1028 and “Average” 1030, respectively, according to an exemplary embodiment of the disclosure herein. For the Diminish module 1026, any input will be diminished by a set amount. This will be the simple multiplication by a value between 0 and 1. Preferably, the result will not be greater than 1. For example, an input of 0.2 and amount of 0.5 (0.2*0.5=0.1). For the Flip module 1028, any input will simply be reversed or subtracted from 1. For example, an input of 0.25 would emerge as 0.75 and an input of 0.9 would emerge as 0.1. For the Average module 1030, two inputs will simply be averaged for the output value. For example, 1.0 and 0.0 is output as a 0.5 value.

FIGS. 17P-17R illustrate icons for software components “Clip” 1032, “Change” 1034 and “Randomize” 1036, respectively, according to an exemplary embodiment of the disclosure herein. For the Clip module 1032, any input that exceeds a certain “value” will be reduced to that value. For example, if the “value is set to 0.7 and the input is 1.0, the value will be reduced to 0.7. For the Change module 1034, a repeated input will be disregarded. Only values that are different from the last value input will be output. For the Randomize module 1036, all inputs will be output as random numbers.

FIGS. 17S-17T illustrate icons for software components “Digitize” 1038 and “Smooth” 1040, respectively, according to an exemplary embodiment of the disclosure herein. The Digitize module 1038 will generate a series of values at a specified rate when the input to the module is past a certain threshold. The amount of the value is set by the output. The Smooth nodule 1040 will store a stream of input values in a buffer and then smooth out the values using principles of interpolation.

It should be appreciated that each of the parameters or controls discussed above for the software components illustrated in FIGS. 17A through 17T is customizable by the user when designing the program for the robotic system. For example, the threshold values, time intervals, and the like, can all be set by the user via the input screen 820 of the programming station 800 during program design. Furthermore, as shown, these parameters are on the sides of the icon for the software component and are displayed virtually on the screen (not on the block with fiducial markers), but move with the block as the user adjusts the positioning of the intermediary module.

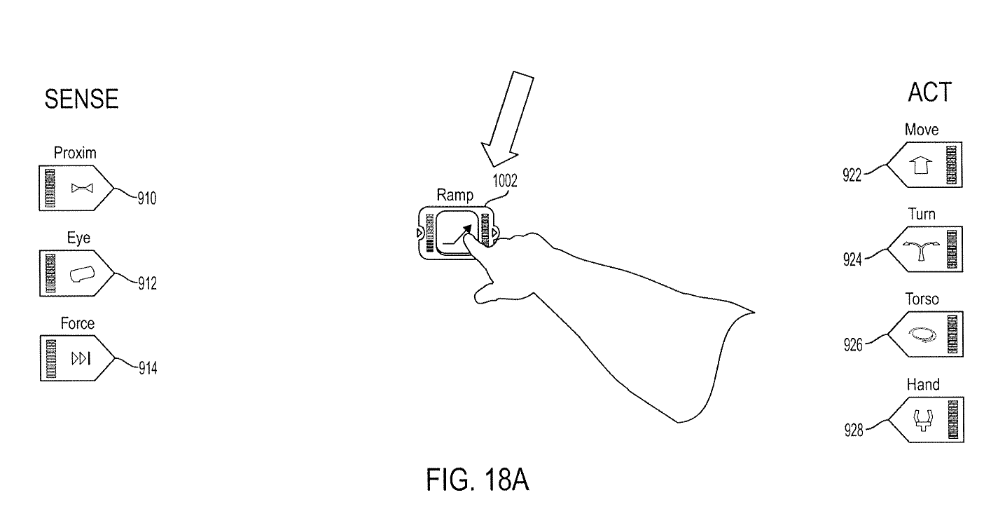

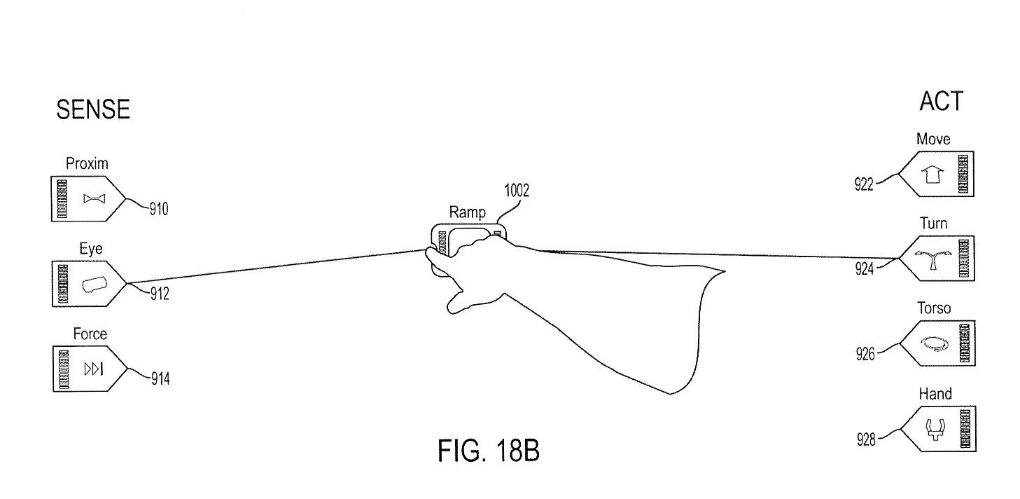

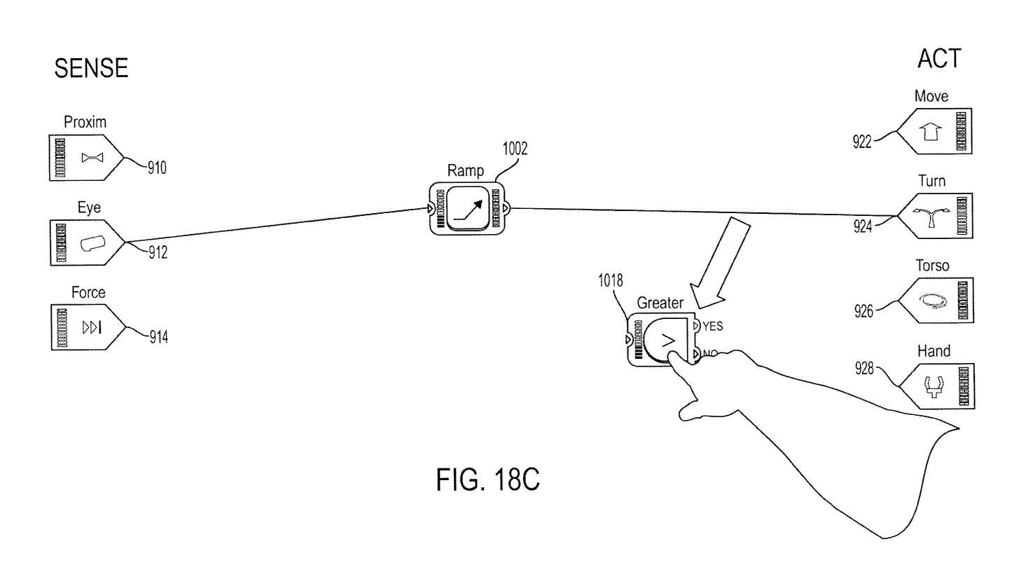

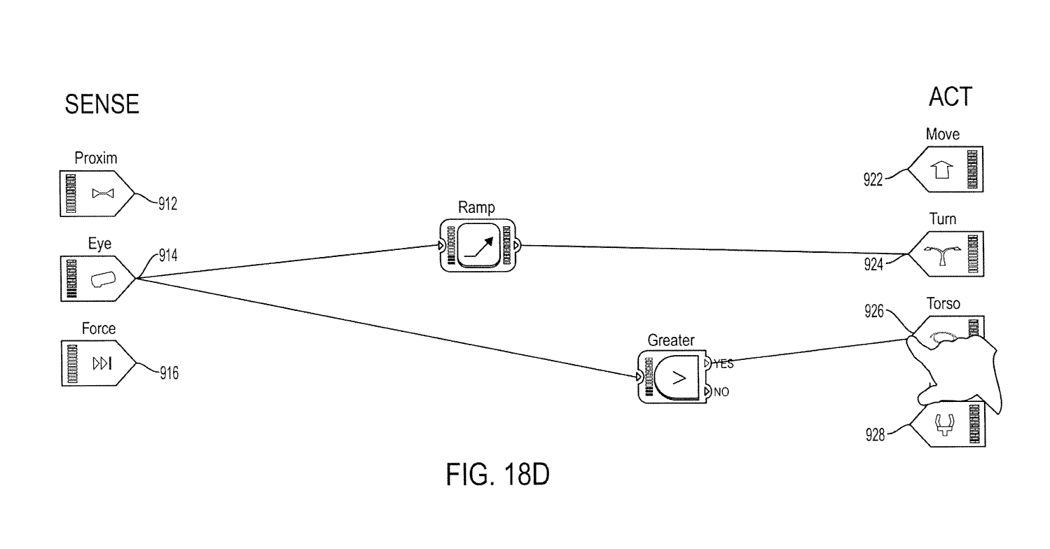

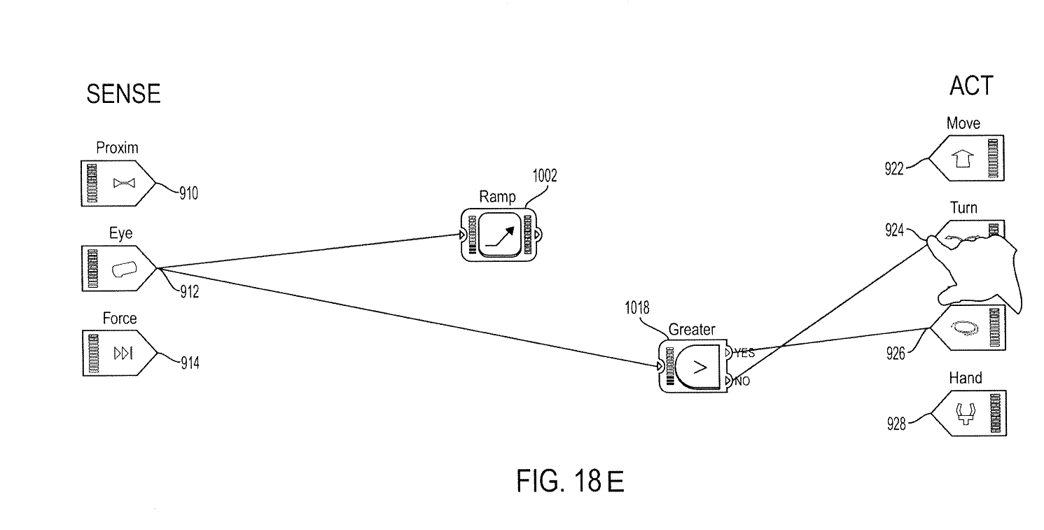

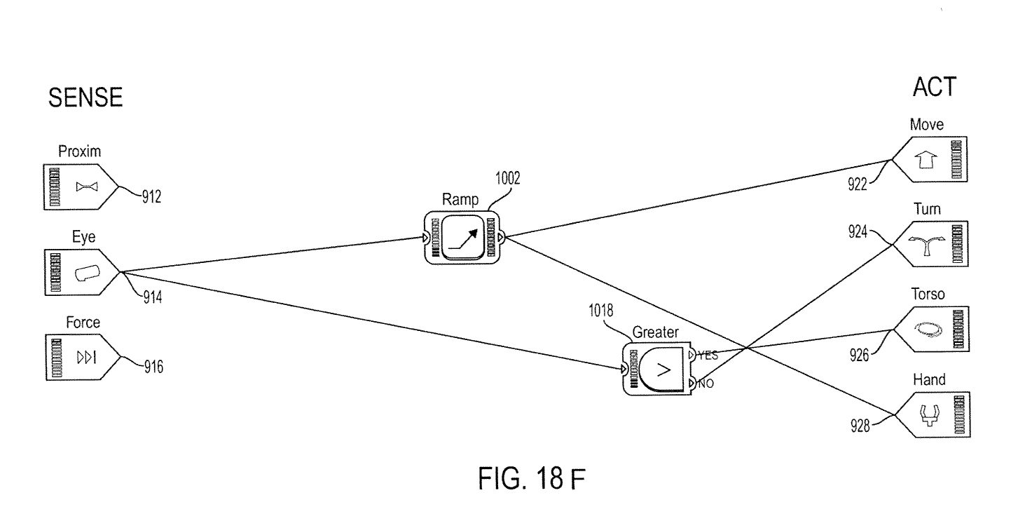

FIGS. 18A-18F illustrate an exemplary method of customizing an operation program for a robot system according to an exemplary embodiment of the disclosure herein. As noted above, once the brain module 500 is coupled to program stating 800, the programming station identifies the input and output modules coupled to the brain module and displays icons representative of the modules on input screen 820. FIG. 18A provides an example of the input screen display to the user. Similar to the example illustrated in FIG. 16, the input screen shown in FIG. 18A includes “Proxim” 910, “Eye” 912 and “Force” 914 sensors and modules “Move” 922, “Turn” 924, “Torso” 926 and “Hand” 928. As further shown, a user can drag a block with fiducial marker onto input screen 820 that identifies with integrated cameras the particular intermediary module to be included in the customized program. In the exemplary embodiment, the intermediary module or software component is the “Ramp” icon 1002 that is positioned between the “Sense” and “Act” icons. The user can then drag connectors between the different components to customize and define an operational relationship between the modules. The user can also adjust the values or parameters of the software component (e.g., the duration of the Ramp function) at that time. As will be discussed below, information relating to the selected software module will be displayed to the user explaining the functionality and other related information.

As next shown in FIG. 18B, the user can connect one of the Sense modules (e.g., the “Eye” or light sensor) to Ramp module 1002 and further connect the output of the Ramp module 1002 to an act sensor (e.g., the “Turn” module). As noted above, in the exemplary embodiment, the Ramp component generates an upward stream of values from 0 to 1 when the input to the module is greater than 0.5 triggers. In this instances, when the light sensor outputs a value greater than 0.5, the robot will turn.

Next, FIG. 18C illustrates the user dragging a compute object onto the input screen 820 (e.g., the “Greater” than software module 1018). FIG. 18D further illustrates the connection of the Eye sensor 912 to the input of the Greater than module 1018, whose output is connected to the Torso module 926. As shown, the input of the Eye sensor 912 (i.e., the column on the left of the icon) is equal to the input of the Greater than module 1018 (i.e., also the column on the left of the icon). Thus, when the input of the Eye sensor 912 reaches the predetermined threshold set by the Greater than module 1018, the robot will rotate about its torso.

FIG. 18E illustrates an example in which the user connects the second output of the Greater than module 1018 to the input of the Turn module 924. By doing so, the connection between the Ramp module 1002 is disconnected because the Turn module 924 can accept only one input at a time. FIG. 18F builds on the example of FIG. 18E by illustrating the user's further customization of the operational control of the robot by connecting the output of the Ramp module 1002 to the Move module 922 and the Hand module 928. Thus, it should be appreciate that an output of a software component can be connected to multiple Act modules in the exemplary embodiment.

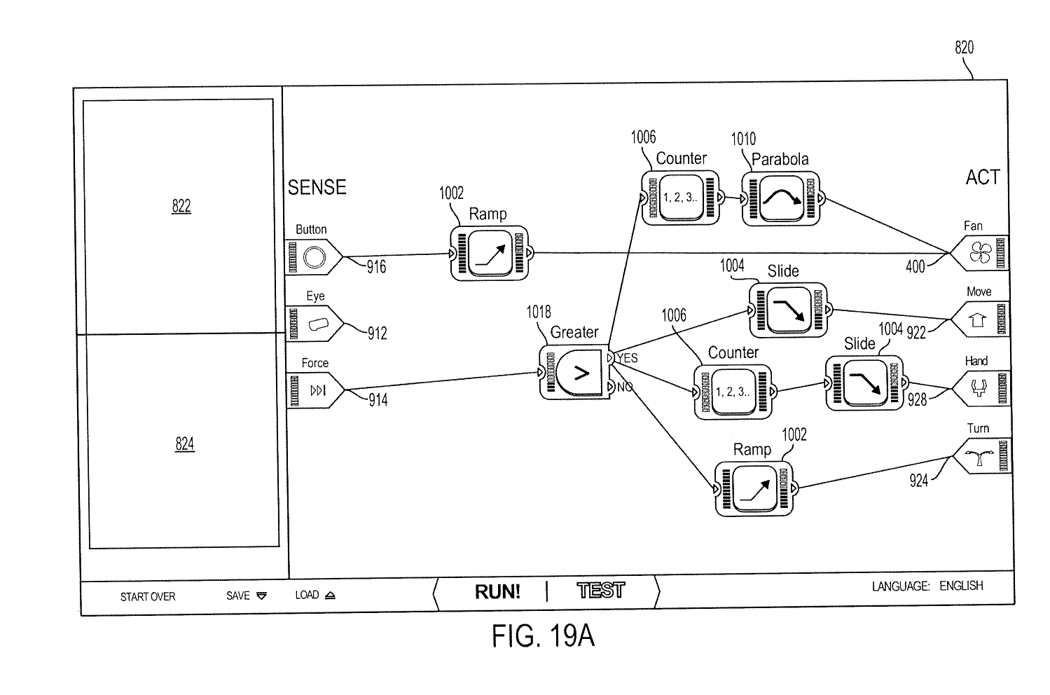

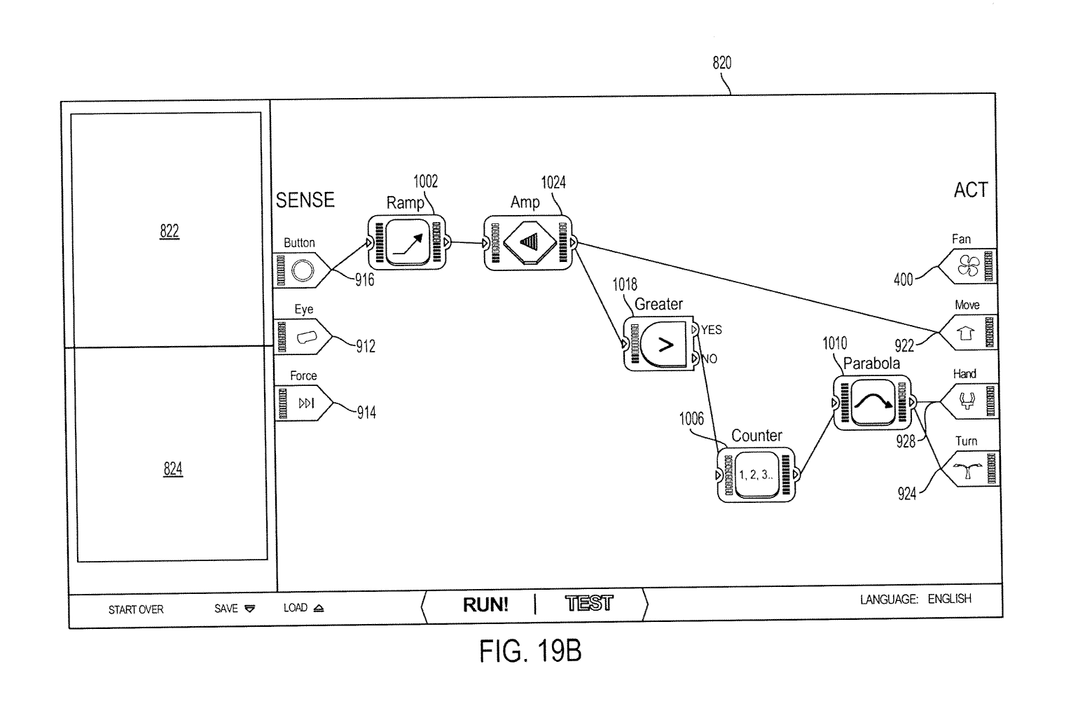

FIGS. 19A and 19B illustrate two exemplary customized programs for the modular robotic according to an exemplary embodiment of the disclosure herein. In FIG. 19A, the Sense or input modules include Eye sensor 912, Force sensor 914 and Button module 916 and the Act or output modules include Fan module 400 (see FIG. 10), Move module 322, Hand module 928, and Turn module 924. As further shown, the user can drag a plurality of software modules onto input screen 820 and drawn a number of connections between the input and output modules. In this instance, the robot has been customized by the user such that: (1) when the button is pressed, the fan will spin once, for three seconds, from low to fast; (2) when the robot hits something, the fan will spin three times with a parabolic motion; (3) when the robot hits something, it will back up five inches; (4) when the robot hits something, the hand will squeeze four times at three second intervals with a 1.5 second duration to close ach time; and (5) when the robot hits something it will turn 90 degrees over the course of two second. It is reiterated the customized operation is performed by the user by first creating and saving the program, before loading the customized operational program onto the memory of the brain module for execution.

FIG. 19B illustrates an alternative customized program in which: (1) the robot will speed forward twelve inches in an accelerated motion when the button is pressed; (2) when the robot has moved twelve inches, it will pinch its hand six times at three second intervals with a 1.5 second duration to close each time; and (3) when the robot has moved twelve inches, it will rotate its torso right to left for six times.

The above description and drawings are only to be considered illustrative of specific embodiments, which achieve the features and advantages described herein. Modifications and substitutions to specific process conditions can be made. Accordingly, the embodiments in this patent document are not considered as being limited by the foregoing description and drawings.

What is claimed is:

1. A user-customizable modular robotic system comprising:
a robot base unit including:
a battery housing containing a power source, and
a magnetic base coupled to the battery housing and having a plurality of magnetic sockets; and
a plurality of modular components, each modular component including:
at least one magnetic coupling member attachable to one of the plurality of magnetic sockets, such that the modular component receives power from the power source when the modular component is attached to the magnetic socket by the at least one magnetic coupling member,
at least one connection port for data communication with another modular component of the plurality of modular components, and
a processor configured to communicate data to the another modular component.

2. The modular robotic system according to claim 1, wherein the magnetic base comprises a rectangular housing extending orthogonally from the battery housing.

3. The modular robotic system according to claim I, wherein the magnetic base includes a plurality of power cables electrically connecting the plurality of magnetic sockets to the power source.

4. The modular robotic system according to claim 1, wherein one of the plurality of modular components is a control module that comprises a plurality of connection ports and an electronic storage medium configured to store a computer program.

5. The modular robotic system according to claim 4, wherein the control module is configured to be communicatively coupled to a programming station having a user interface.

6. The modular robotic system according to claim 5, wherein, when the control module is communicatively coupled to the programming station, the user interface displays a plurality of icons representing the modular components coupled to the plurality of connection ports of the control module.

7. The modular robotic system according to claim 6, wherein the user interface is configured to receive input instructions from a user to customize operational relationships between at least two of the modular components coupled to the plurality of connection ports of the control module.

8. The modular robotic system according to claim 7, where the user interface is further configured to display a plurality of functional software modules and to receive input instructions from a user to customize the operational relationship between at least two of the modular components using at least one of the plurality of functional software modules.

9. The modular robotic system according to claim 1, wherein the robot base unit includes a plurality of casters configured to move the robot base unit.

10. The modular robotic system according to claim 1, wherein the robot base unit includes a charging port configured to magnetically couple the robot base unit to a docking station.

11. The modular robotic system according to claim 10, wherein the power source is configured to be recharged by electromagnetic coupling when the charging port is magnetically coupled to the docking station.

12. The modular robotic system according to claim 1, further comprising a single cable connector configured to magnetically couple two modular components of the plurality of modular components and to serially communicate the data between the two coupled modular components.

13. A method for customizing a modular robotic system, which includes a robot base unit having a battery housing containing a power source and a magnetic base coupled to the battery housing and having a plurality of magnetic sockets, and a plurality of modular components, each modular component including at least one magnetic coupling member, at least one connection port for data communication with a connected modular component, and a processor configured to transmit data to the connected modular component, the method comprising:
attaching at least three of the plurality of modular components to respective magnetic sockets of the magnetic base, where one of the three modular components is a control module having a processor and electronic memory;
attaching respective cable connectors between connection ports of the control module and connection ports of the other two modular components;
communicatively coupling the control module to a programming station; and
loading, by the programming station, a computer program onto the electronic memory of the control module coupled to the programming station,
wherein the computer program establishes a communication protocol between the control module and the other two modular components when the computer program is executed by the processor of the control module.

14. The method for customizing a modular robotic system according to claim 13, wherein one component of the other two modular components is an input component and the other component of the other two modular components is an output component.

15. The method for customizing a modular robotic system according to claim 14, further comprising receiving a user input, by an input screen of the programming station, to customize the computer program.

16. The method for customizing a modular robotic system according to claim 15, wherein the user input provides a functional relationship between the input component and the output component.

17. The method for customizing a modular robotic system according to claim 16, wherein the control module executes the functional relationship between the input component and the output component when the computer program is executed by the processor of the control module.

18. The method for customizing a modular robotic system according to claim 17, further comprising displaying icons representing a plurality of functional software modules.

19. The method for customizing a modular robotic system according to claim 18, further comprising receiving input instructions from the user, by the input screen of the programming station, to customize the functional relationship between the input component and the output component using at least one of the plurality of functional software modules.

20. The method for customizing a modular robotic system according to claim 15, wherein the user input includes instructions for setting variable parameters of at least one of the other two modular components coupled to the control module.
